(19) United States
(12) Patent Application Publication
(10) Pub. No.: US 2011/0080129 A1
(43) Pub. Date: Apr. 7, 2011

(54) SINGLE-PIN MULTIFUNCTIONAL DEVICE AND METHOD FOR INPUT AND OUTPUT IN CONTROLLING A DIRECT-CURRENT FAN

(76) Inventors: Chang-Ling SHA, Hsinchu City (TW); Ko-Ming Lin, Hsinchu City (TW); Wei-Chuan Su, Hsinchu City (TW)

(21) Appl. No.: 12/571,770

(22) Filed: Oct. 1, 2009

(51) Int. Cl. G05D 23/20

(52) U.S. Cl. 318/471

(57) ABSTRACT

A single-pin multifunctional device and method for input and output in controlling a direct-current fan use a control chip to control an operation of the fan, thereby protecting issues generated by too high a temperature. The control chip uses a value of a temperature induction unit to determine a range of protection and maintains the fan at an idle speed operation through an idle speed regulation unit. Meanwhile, the temperature induction unit notifies an over-temperature protection unit to switch from the idle speed regulation unit to the over-temperature protection unit. Therefore, the fan is controlled through a single pin to input and output simultaneously.

### BACKGROUND OF THE INVENTION

a) Field of the Invention

The present invention relates to a single-pin multifunctional device and method in controlling a direct-current fan and more particularly to a single-pin multifunctional device and method for input and output in controlling a direct-current fan.

b) Description of the Prior Art

Most current electronic devices or equipment have already used a digitized function. Among them a computer is especially representative. The computer not only is digitized but also is a multifunctional device as a lot of problems or items that many people cannot deal with can be processed by the computer and the computer can be used for a purpose of querying or entertaining. Through many years of improvement and evolution, many computers have been expanded or upgraded with functions based upon needs and requests of general public to comply with the requirements of general public. It is natural that when data to be processed by a computer increases, a working frequency of a central processing unit becomes higher and energy consumption is larger, resulting in that a temperature inside the computer rises up accordingly. When the temperature rises up to a certain level, an entire efficiency of the computer will drop down slowly due to imperfect heat dissipation. At this time, a user should reboot or force to reduce the temperature inside the computer that an operating speed of the computer can be recovered effectively.

To solve the aforementioned issues, it is most realistic and practical to use a fan and the temperature inside the computer can be effectively reduced by increasing the rotation speed of the fan. Therefore, a shortcoming that a computer system is malfunctioning, due to that a working temperature is too high, can be avoided effectively. When a system temperature is too high, a warning is sent out to remind the system to activate a protection mechanism to prevent the system from being burnt down. On an existing market, a chip which is used to control an operation of the fan and is provided with an over-temperature alert function needs to be equipped with a dedicated pin for the over-temperature alert function, so that a perfect fan control function can be provided.

However, when the aforementioned fan is in use, following issues and shortcomings actually exist for improvement.

When the fan is running in a full speed and the temperature is high, the aforementioned chip pin which controls the operation of the fan is unable to achieve a single-pin multifunctional effect and a dedicated pin which outputs an over-temperature alert signal independently is required.

As more pins also take up more PCB (Printed Circuit Board) space, a production cost will be higher.

Accordingly, how to solve the aforementioned issues and shortcomings of the prior art is to be researched and developed for improvement by the present inventor and related vendors.

### SUMMARY OF THE INVENTION

The primary object of the present invention is to provide a single-pin multifunctional device and method for input and output in controlling a direct-current fan, wherein an operation of the fan device is controlled by a control chip and the control chip includes primarily an idle speed regulation unit which performs an idle speed control by reading a divider ratio of two resistances through one pin, a temperature induction unit which detects an ambient temperature and an over-temperature protection unit. When the temperature induction unit detects that the ambient temperature is higher than a pre-set temperature, the over-temperature protection unit is notified to switch from the idle speed regulation unit to the over-temperature protection unit which sends out an alert signal through the aforementioned pin. By the aforementioned technologies, an advantage of a single-pin with multiple functions can be achieved, thereby protecting the issues which are caused by over-temperature. On the other hand, same functions and effects can be achieved by using much fewer pins than the prior art. Moreover, as the pins of the control chip are decreased, an area needed by the PCB is diminished, which also achieves an advantage of saving a cost and provides a user with more spaces to use.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a system block diagram of a control chip of the present invention.

FIG. 1A shows a flow diagram of steps of a preferred embodiment of the present invention.

FIG. 2 shows a first schematic view of a single-pin multifunctional operation of the present invention.

FIG. 3 shows a second schematic view of a single-pin multifunctional operation of the present invention.

### DETAILED DESCRIPTION OF THE PREFERRED EMBODIMENTS

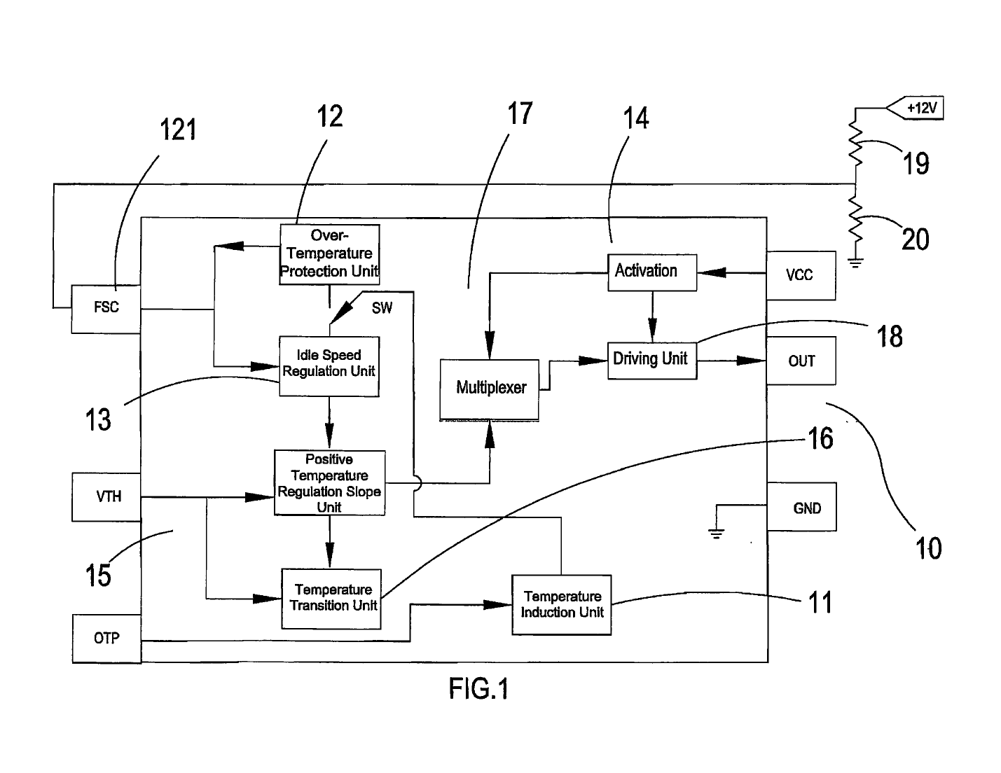

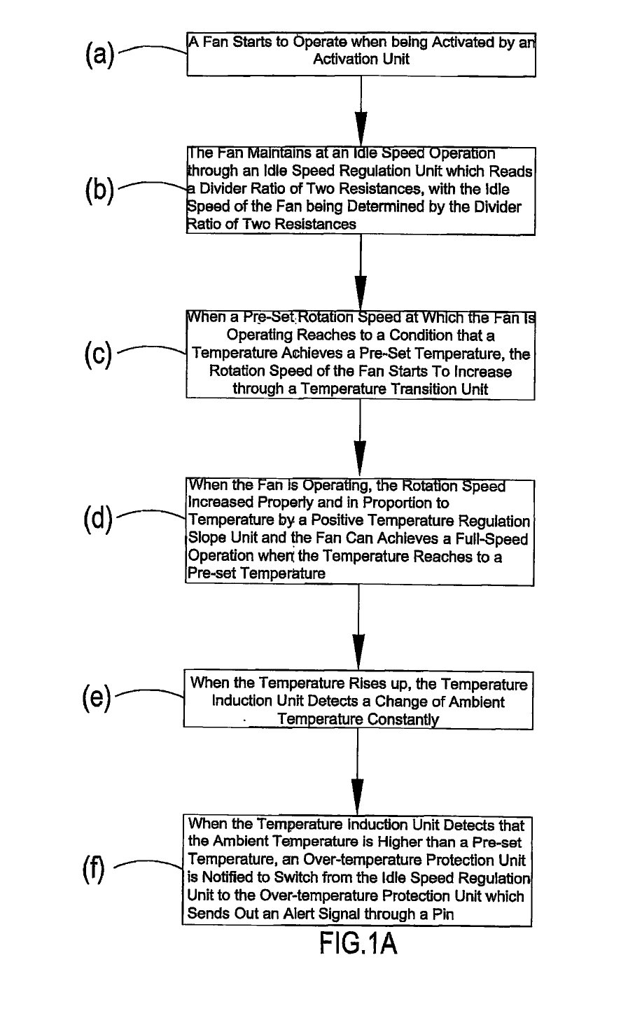

Referring to FIG. 1, it shows a system block diagram of a control chip of the present invention. As shown in the drawing, the present invention uses a control chip 10 to control an operation of a fan device, wherein the control chip 10 comprises primarily a temperature induction unit 11 which is connected with a thermistor to detect a change of resistance of an ambient thermistor, so as to induce a change of temperature; an idle speed regulation unit 13 which controls an idle-speed operation of the fan by reading a divider ratio of two resistances 19, 20 through a pin 121; an over-temperature protection unit 12, the temperature induction unit 11 notifying the idle speed regulation unit 13 to switch to the over-temperature protection unit 12 to send out an alert signal through the pin 121, when the fan is running in a full speed and the over-temperature protection unit 12 detects that an ambient temperature is higher than a pre-set temperature; an activation unit 14 which provides a pre-set voltage and drives the fan to rotate; a positive temperature regulation slope unit 15 which increases the rotation speed properly and in proportion to the temperature when the rotation speed of the fan increases, allowing the fan to rotate at the full speed when reaching to a pre-set temperature; a temperature transition unit 16 which starts to increase the rotation speed of the fan when reaching to a pre-set temperature; and an multiplexer 17 which is used for multiplexer for the control chip 10 and generates a drive signal to a driving unit 18; and the driving unit 18 which provides driving energy to the fan.

Referring to FIG. 1A, it shows a flow diagram of steps of a preferred embodiment of the present invention. As shown in the drawing, the steps are:
(a) the fan starting to rotate when being activated by the activation unit;
(b) reading a divider ratio of two resistances through the idle speed regulation unit to maintain the fan at an idle-speed operation, with the idle speed being determined by the divider ratio of the two resistances;
(c) starting to increase the rotation speed of the fan through the temperature transition unit when a pre-set rotation speed that the fan is operating at reaches to a condition that the temperature increases to a pre-set temperature;
(d) using the positive temperature regulation slope unit to increase the rotation speed properly and in proportion to the temperature when the fan is operating, allowing the fan to achieve the full speed rotation when the temperature reaches to a pre-set temperature;
(e) the temperature induction unit detecting an ambient temperature constantly when the temperature rises up; and
(f) the temperature induction unit notifying the over-temperature protection unit to switch from the idle speed regulation unit to the over-temperature protection unit which sends out an alert signal through the pin, when the temperature induction unit detects that the ambient temperature is higher than a pre-set temperature.

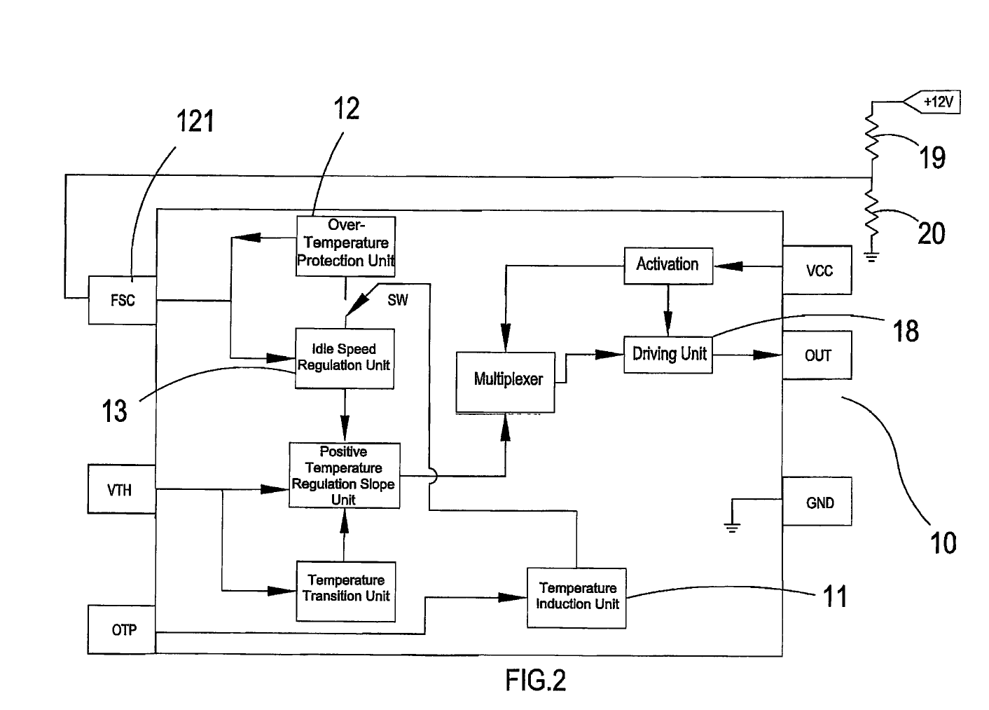

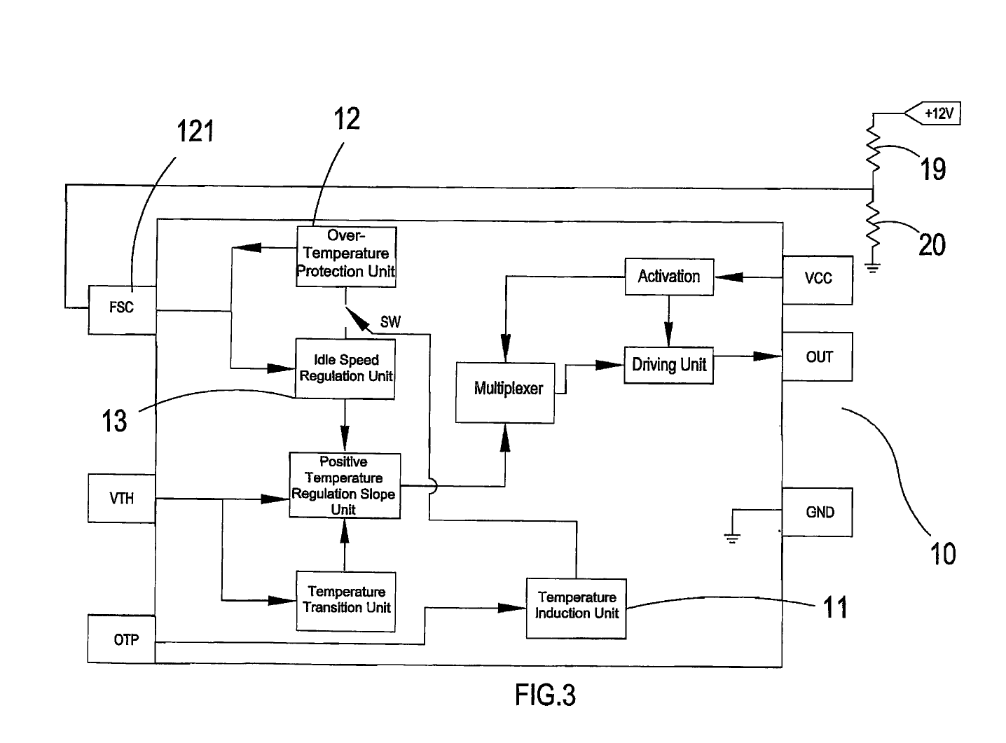

Referring to FIG. 2 and FIG. 3, it shows a first and a second schematic view of a single-pin multifunctional operation. As shown in the drawings, the control chip 10 is used as a medium to control the rotation speed of the fan and the said control chip 10 includes primarily the temperature induction unit 11 which detects the ambient temperature, the idle speed regulation unit 13 which reads the divider ratio of two resistances 19, 20 through the pin 121, the over-temperature protection unit 12, the temperature induction unit 11 notifying the idle speed regulation unit 13 to switch to the over-temperature protection unit 12 to send out the alert signal through the pin 121, when the fan is running in the full speed and the temperature induction unit 11 detects that the ambient temperature is higher than a pre-set temperature. Moreover, when the fan starts to operate, the fan will maintain at the idle-speed operation by the idle speed regulation unit 13 and the idle speed regulation unit 13 reads the divider ratio of two resistances 19, 20 to control the fan to operate at the idle speed. On the other hand, as shown in FIG. 3, when heat energy is produced by the system after running for a pre-set time, the temperature can increase by the heat energy, allowing the temperature induction unit 11 to induce an increase of the temperature. When the temperature is higher than a level, the fan will achieve the full-speed operation. At a same time, a next action is executed when the temperature induction unit 11 detects that the temperature is higher than a pre-set temperature. As a result, the over-temperature protection unit 12 will send out an over-temperature alert signal to an exterior side, warning the system to execute a next task through the signal.

Accordingly, the key technologies that the single-pin multifunctional device and method for input and output in controlling the direct-current fan, according to the present invention, can improve the prior art lie in that:
1. The control chip 10 can achieve a full function by using fewer pins (within 6 pins).
2. The control chip 10 can carry out a full function with an input signal and an output signal by using a single pin.
3. As the pins of the control chip 10 which controls the operation of the fan are decreased, a size and an area of the PCB are diminished; this also achieves an object of saving a cost.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A single-pin multifunctional device for input and output in controlling a direct-current fan, including a control chip to control an operation of the fan device and the control chip comprising primarily:
a temperature induction unit which is connected with a thermistor to induce a change of ambient temperature;
an over-temperature protection unit which sends out a signal through a pin when the fan is running at a full speed and the temperature induction unit detects that an ambient temperature is higher than a pre-set value; and
an idle speed regulation unit, which reads a divider ratio of two resistances through the pin to control the fan to operate at an idle speed.

2. The single-pin multifunctional device for input and output in controlling a direct-current fan according to claim 1, wherein the control chip further includes an activation unit, a temperature transition unit, a positive temperature regulation slope unit, an multiplexer and a driving unit.

3. A single-pin multifunctional method for input and output in controlling a direct-current fan, comprising:
(a) the fan starting to operate when being activated by an activation unit;
(b) the fan maintaining at an idle-speed operation by an idle speed regulation unit, with the idle sped of the fan being determined by a divider ratio of two resistances;
(c) a rotation speed of the fan starting to increase through a temperature transition unit, when a pre-set rotation speed that the fan is operating reaches to a condition that the temperature reaches to a pre-set temperature;
(d) when the fan is operating, a positive temperature regulation slop unit increasing the rotation speed of the fan properly and in proportion to the temperature, allowing the fan to operate at a full speed when the temperature reaches to a pre-set temperature;
(e) when the temperature increases, the temperature induction unit detecting a change of ambient temperature constantly; and
(f) when the temperature induction unit detect that the ambient temperature is higher than a pre-set temperature, the temperature induction unit notifying an over-temperature protection unit to switch from the idle speed regulation unit to the over-temperature protection unit which sends out an alert signal through a pin.

4. The single-pin multifunctional method for input and output in controlling a direct-current fan according to claim 3, wherein the idle speed regulation unit is connected with a positive temperature regulation slope unit.

5. The single-pin multifunctional method for input and output in controlling a direct-current fan according to claim 4, wherein the positive temperature regulation slope unit is connected with an multiplexer.

6. The single-pin multifunctional method for input and output in controlling a direct-current fan according to claim 3, wherein the temperature induction unit is connected with a thermistor to induce a change of ambient temperature.
